(19) United States
(12) Patent Application Publication
(10) Pub. No.: US 2013/0333041 A1
(43) Pub. Date: Dec. 12, 2013

(54) Method and Apparatus for Automatic Identification of Affected Network Resources After a Computer Intrusion

(71) Applicants: Mihai Christodorescu, Briarcliff Manor, NY (US); Josyula R. Rao, Briarcliff Manor, NY (US); Reiner Sailer, Scarsdale, NY (US); Douglas Lee Schales, Ardsley, NY (US)

(72) Inventors: Mihai Christodorescu, Briarcliff Manor, NY (US); Josyula R. Rao, Briarcliff Manor, NY (US); Reiner Sailer, Scarsdale, NY (US); Douglas Lee Schales, Ardsley, NY (US)

(73) Assignee: INTERNATIONAL BUSINESS MACHINES CORPORATION, Armonk, NY (US)

(21) Appl. No.: 13/494,108

(22) Filed: Jun. 12, 2012

(51) Int. Cl. G06F 21/00

(52) U.S. Cl. 726/24

(57) ABSTRACT

Methods and apparatus are provided for automatic identification of affected network resources after a computer intrusion. The network resources affected by a computer intrusion can be identified by collecting information about an external system from an external source; deriving a list of one or more affected internal systems on an internal network by correlating the information with internal information about internal systems that interacted with the external system; and identifying one or more user accounts associated with the one or more affected internal systems. Data residing on systems accessible by the one or more user accounts can also optionally be identified. A list can optionally be presented of the network resources that may be affected by the computer intrusion. The affected network resources can be, for example, servers, services and/or client machines.

### FIELD OF THE INVENTION

The present invention relates to network security techniques.

### BACKGROUND OF THE INVENTION

Network security techniques aim to prevent unauthorized access of a computer network and/or network-accessible resources (such as network-connected equipment or services). A Network Intrusion Detection System (NIDS), for example, attempts to detect an unauthorized access to a computer network by analyzing traffic on the network for signs of malicious activity. Antivirus software is used to prevent, detect, and remove malware, including computer viruses, computer worms, and other malicious software from computers.

Existing network security techniques, however, typically identify a particular problem on a given infected computer, such as a particular computer or a particular user account on a network service that has been attacked, without any further knowledge of additional computers or user accounts that may have been attacked. Known techniques generally rely on manual forensic analysis or on having each computer on the network run audit software that collects local activity data to be used in case an intrusion is detected. Such existing techniques, however, are not scalable and are open to attack.

A need therefore exists for improved methods and apparatus for automatically identifying the network resources (such as servers, services, and client machines) that are affected by a computer intrusion.

### SUMMARY OF THE INVENTION

Generally, methods and apparatus are provided for automatic identification of affected network resources after a computer intrusion. According to one aspect of the invention, one or more network resources affected by a computer intrusion are identified by collecting information about an external system from an external source; deriving a list of one or more affected internal systems on an internal network by correlating the information with internal information about internal systems that interacted with the external system; and identifying one or more user accounts associated with the one or more affected internal systems. Data residing on systems accessible by the one or more user accounts can also optionally be identified. A list can optionally be presented of the network resources that may be affected by the computer intrusion.

The network resources can be, for example, servers, services and/or client machines. The external source can be, for example, a provider of an antivirus product or a law enforcement agency. The external system can be, for example, an infected system or a malicious system. The internal information comprises, for example, internal network activity, internal e-mail content and/or authentication logs. The user accounts associated with the one or more affected internal systems can be, for example, accounts of a user who has access to at least one of the affected internal systems.

The list of one or more affected internal systems can be derived by marking an identified internal system as infected and marking any additional internal systems that communicated with an identified external host as infected. In addition, any internal system that communicated with an infected internal system can optionally be marked as infected. Any internal system with a communication profile similar to an infected system can also optionally be marked as infected.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary network environment in which the present invention can be operated;

FIG. 2 is a flow chart describing an exemplary implementation of a computer intrusion management process that may be executed by a computer intrusion management system that incorporates aspects of the present invention;

FIG. 3 illustrates the computer intrusion management process of FIG. 2 in a graphical manner;

FIG. 4 is a flow chart describing an exemplary implementation of an infected system list generation process incorporating aspects of the present invention;

FIG. 5 is a flow chart describing an exemplary implementation of an affected user account list generation process incorporating aspects of the present invention;

FIG. 6 is a flow chart describing an exemplary implementation of a potential affected data identification process incorporating aspects of the present invention; and

FIG. 7 is a block diagram of a computer intrusion management system that can implement the processes of the present invention.

### DETAILED DESCRIPTION OF PREFERRED EMBODIMENTS

The present invention provides improved methods and apparatus for automatically identifying the network resources (such as servers, services, and client machines) that are affected by a computer intrusion. According to one aspect of the invention, summary information of network events (collected and computed, for example, continuously) is used to determine the extent of an intrusion. Initially, a particular computer or a particular account on a network service that has been attacked is identified. The events triggered by the intruder is constructed using information about the other computers, services, and network resources that were accessed and accessible from the attacked computer account. A report is optionally generated that describes the computers and services whose integrity should be checked.

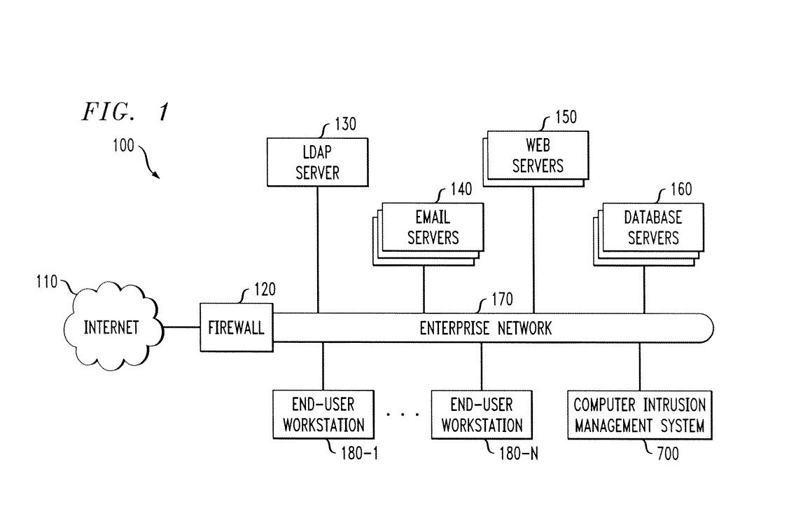

FIG. 1 illustrates an exemplary network environment 100 in which the present invention can be operated. As shown in FIG. 1, one or more end-user workstations 180-1 through 180-N communicate over an enterprise network 170 with one another, and with an LDAP (Lightweight Directory Access Protocol) server 130, one or more email servers 140, one or more web servers 150 and one or more database servers 160, in a known manner. Generally, the LDAP server 130 provides access to distributed directory information services, in a known manner. In addition, the workstations 180 and servers 130, 140, 150, 160 can access the Internet 110 (or World Wide Web) via a security firewall 120, in a known manner.

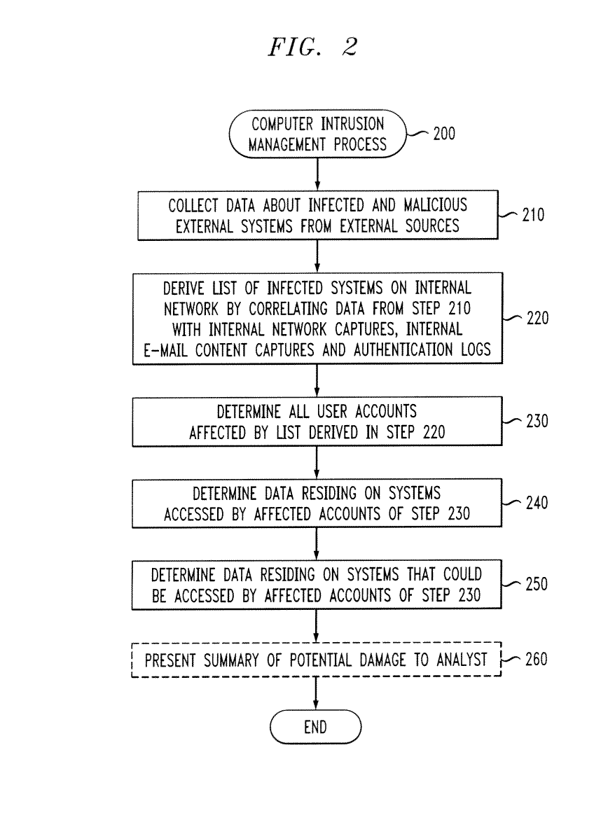

According to one aspect of the present invention, a computer intrusion management system 700 connected to the enterprise network 170 automatically identifies the resources (such as servers, services, and client machines) on the enterprise network 170 that are affected by a computer intrusion. The processes associated with the computer intrusion management system 700 are discussed further below in conjunction with FIGS. 2 through 6. The system aspects of the computer intrusion management system 700 are discussed further below in conjunction with FIG. 7.

FIG. 2 is a flow chart describing an exemplary implementation of a computer intrusion management process 200 that may be executed by a computer intrusion management system 700 that incorporates aspects of the present invention. As shown in FIG. 2, the computer intrusion management process 200 initially collects data about infected and malicious external systems from external sources (e.g., antivirus companies) during step 210. For example, the external sources may obtain the data by monitoring one or more of email, Domain Name Server (DNS) information, port and protocol usage, and web traffic. The external source may provide the data in the form of DNS names and/or IP addresses associated with a threat.

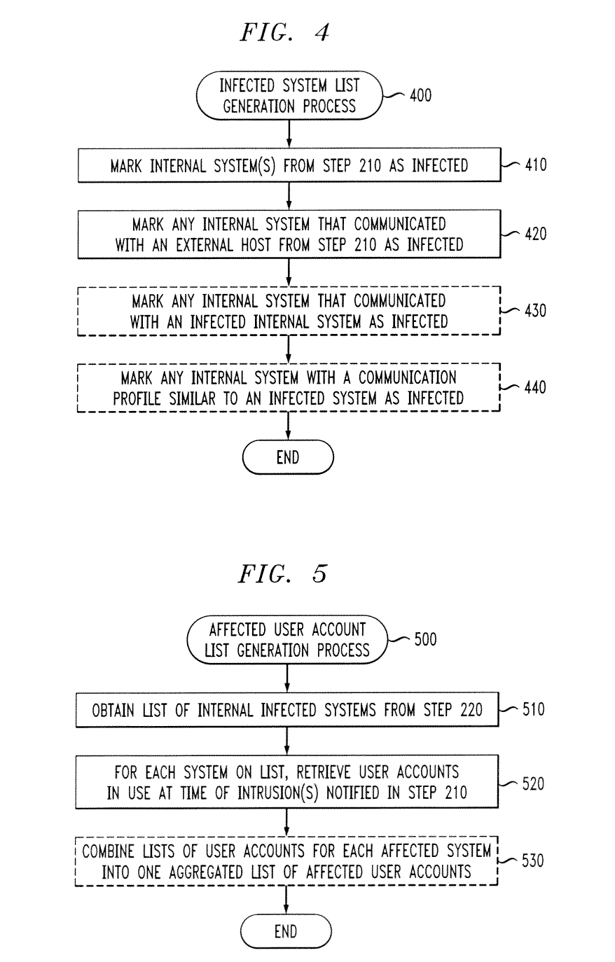

Thereafter, a list is derived during step 220 of infected systems on the internal (enterprise) network by correlating data from step 210 with internal network captures, internal e-mail content captures, and authentication logs, as discussed further below in conjunction with FIG. 4.

A list of user accounts is determined during step 230 that are affected by the list derived in step 220, as discussed further below in conjunction with FIG. 5.

The data that resides on the systems that were accessed by the affected accounts of step 230 is determined during step 240. For example, for each system in the list constructed during step 220, the computer intrusion management process 200 retrieves information about the data stored on that system. This information can be obtained, for example, from an information-management system or more specifically from an enterprise information-security management (EISM) system. This information about the data can include, for example, the type of data stored, its sensitivity, the amount of data, and other security-relevant metrics.

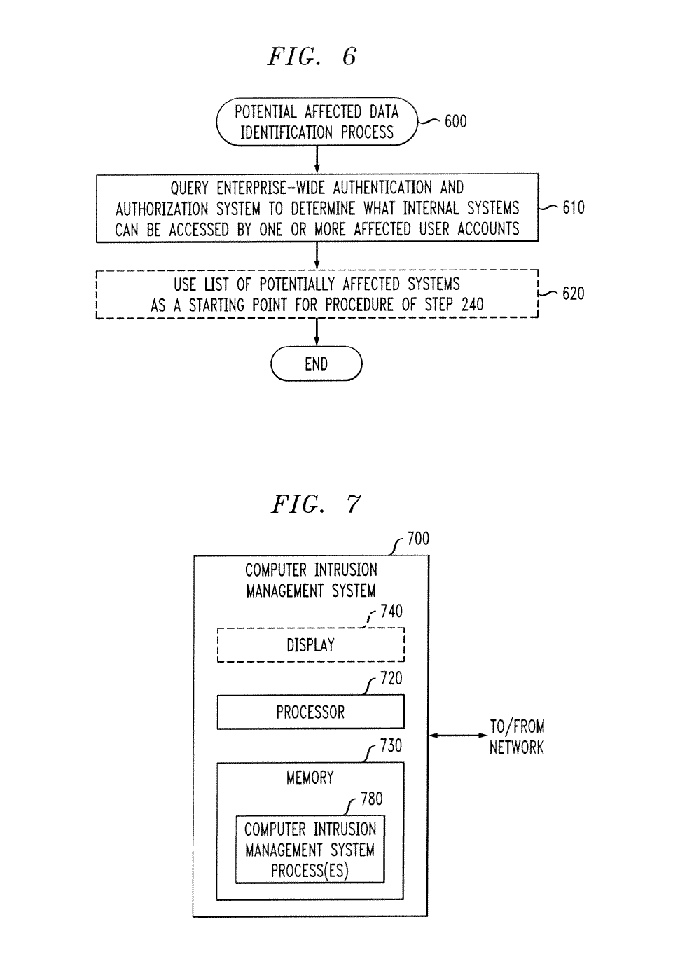

The data that resides on the systems that could be accessed by the affected accounts of step 230 is determined during step 250, as discussed further below in conjunction with FIG. 6.

Finally, the potential damage from the data of steps 240 and 250 is summarized during step 260 and optionally presented to an analyst for implementation of prevention/recovery measures. For example, the computer intrusion management process 200 can collate the information obtained in steps 240 and 250 to display to a system or security analyst an actionable summary of the intrusion. This display optionally includes information about the data residing on affected systems (from step 240), representing data that is very likely to have been impacted by the intrusion. The display optionally also includes information about the data residing on potentially affected systems, representing data that might have been impacted by the intrusion. Since the amount of data can be quite large for an enterprise network, the exemplary computer intrusion management process 200 can optionally group data items based on risk factors that take into account the sensitivity of the data and the probability of actual intrusion on the internal system storing the data.

One exemplary computer intrusion management process 200 uses a display component that provides the analyst with drill-down capabilities, such that the analyst can start with a brief summary of the data affected by the intrusion, and then has the option to repeatedly ask for more information about each affected data item and each affected (or potentially affected) internal system. Based on this information, the analyst can take prevention and/or recovery measures using tools, techniques, and procedures not covered by this invention.

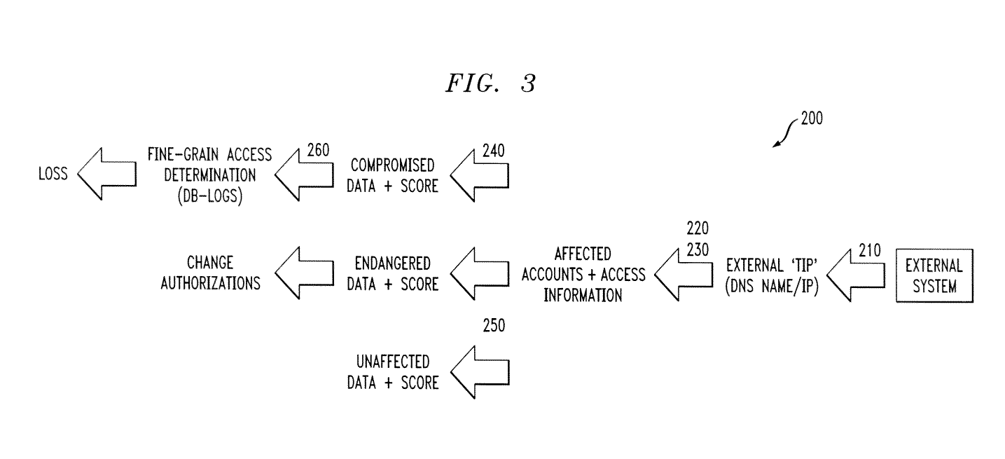

FIG. 3 illustrates the computer intrusion management process 200 of FIG. 2 in a graphical manner. As shown in FIG. 3, the computer intrusion management process 200 proceeds from right to left (corresponding to the backwards-through-time progression of the analysis steps). For example during step 210, the computer intrusion management process 200 may receive data about infections and intrusions from one or more external systems, such as DNS names and/or IP addresses associated with a threat. The data about infections and intrusions specifies one or more systems on the internal network that are the target of an infection or intrusion. For example, a data item could mention that a given system X on the internal network communicated with a known-malicious external website Y, or that a given system Z on the internal network is sending spam email messages. The time of the communication described in the data item can be close to the present time or could have occurred in the past. Internal systems are normally identified by their IP address, but other possibilities exist (e.g., by host name, by MAC address, by user name). The external parties that provide this data could be, for example, anti-virus companies, in which case the data typically comes in the form of a blacklist that is regularly queried by the computer intrusion management process 200, or law-enforcement agencies, such as the FBI, in which case the data is typically provided to an administrator of an internal network.

The processing performed during steps 220 and 230 generates lists of infected systems and the corresponding user accounts that used the infected systems. The processing performed during steps 240 and 250 generates lists of the data residing on affected systems that were or could have been accessed by affected accounts.

Finally, a summary of the potential damage is optionally presented to an analyst during step 260.

As previously indicated, a list is derived during step 220 of infected systems on the internal (enterprise) network by correlating data from step 210 with internal network captures, internal e-mail content captures, and authentication logs. FIG. 4 is a flow chart describing an exemplary implementation of an infected system list generation process 400 incorporating aspects of the present invention. As shown in FIG. 4, the exemplary infected system list generation process 400 generates the list of infected systems on the internal network by using the IP address of the internal system identified in step 210, as follows:

The internal system from step 210 is marked as infected during step 410. Any internal system that communicated with an external host specified in step 210 is marked as infected during step 420.

In addition, any internal system that communicated with an infected internal system is optionally marked as infected during step 430. Any internal system with a communication profile similar to that of an infected system is optionally marked as infected during step 440.

The rules of FIG. 4 rely on a variety of techniques to contrast the list of all the infected system on the internal network. These techniques can include, for example, custom databases to store summaries of past network traffic and to query such summaries efficiently, and statistical approaches to compute and compare communication profiles of internal systems. A communication profile can include, as an example, a summary of the external hosts contacted by an internal system on a regular basis, together with frequency information (e.g., “system X contacted external host Y 100 times per day”).

As previously indicated, a list is derived during step 230 of user accounts that are affected by the list derived in step 220. FIG. 5 is a flow chart describing an exemplary implementation of an affected user account list generation process 500 incorporating aspects of the present invention. Generally, an affected user account represents the account of a user who has access to at least one of the infected internal systems. As shown in FIG. 5, the exemplary affected user account list generation process 500 initially obtains, during step 510, the list constructed during step 220. Thereafter, the exemplary affected user account list generation process 500 retrieves the user accounts during step 520 that were in use over the time period of the intrusion notified in step 210, for each system in the list constructed during step 220. For example, the affected user account list generation process 500 can obtain the user accounts for a given system by querying the summaries of past network traffic and identifying the users that performed a login to the given system before the time of the intrusion and did not log out until after the time of the intrusion. The lists of user accounts for each affected system are optionally combined into one aggregated list of affected user accounts during step 530.

As previously indicated, the data that resides on the systems that could be accessed by the affected accounts of step 230 is determined during step 250. FIG. 6 is a flow chart describing an exemplary implementation of a potential affected data identification process 600 incorporating aspects of the present invention. Generally, the analysis performed by the potential affected data identification process 600 is similar to the analysis of step 640, with the significant distinction being the internal systems that are considered. While step 240 uses the list of affected systems (constructed at step 220), the potential affected data identification process 600 builds a new list of internal systems that might have been accessed by any one affected user since the intrusion occurred.

As shown in FIG. 6, the exemplary potential affected data identification process 600 initially queries an enterprise-wide authentication and authorization system (such as LDAP server 130 or an ActiveDirectory server) during step 610 to determine what internal systems can be accessed by one or more users from the list constructed by the affected user account list generation process 500 during step 230. Alternatively, the invention queries each internal system on the enterprise network 170 in turn to determine whether a user from the list in step 230 could access that internal system.

Finally, the list of potentially affected systems is used during step 620 as a starting point for the procedure of step 240.

While FIGS. 2 through 6 show exemplary sequences of steps, it is also an embodiment of the present invention that these sequences may be varied. Various permutations of the algorithms are contemplated as alternate embodiments of the invention.

While exemplary embodiments of the present invention have been described with respect to processing steps in a software program, as would be apparent to one skilled in the art, various functions may be implemented in the digital domain as processing steps in a software program, in hardware by a programmed general-purpose computer, circuit elements or state machines, or in combination of both software and hardware. Such software may be employed in, for example, a hardware device, such as a digital signal processor, application specific integrated circuit, micro-controller, or general-purpose computer. Such hardware and software may be embodied within circuits implemented within an integrated circuit.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 7 is a block diagram of a computer intrusion management system 700 that can implement the processes of the present invention. As shown in FIG. 7, memory 730 configures the processor 720 to implement the robot navigation and equipment classification methods, steps, and functions disclosed herein (collectively, shown as 780 in FIG. 7). The memory 730 could be distributed or local and the processor 720 could be distributed or singular. The memory 730 could be implemented as an electrical, magnetic or optical memory, or any combination of these or other types of storage devices. It should be noted that each distributed processor that makes up processor 720 generally contains its own addressable memory space. It should also be noted that some or all of computer system 700 can be incorporated into a personal computer, laptop computer, handheld computing device, application-specific circuit or general-use integrated circuit.

The flowcharts and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that the embodiments and variations shown and described herein are merely illustrative of the principles of this invention and that various modifications may be implemented by those skilled in the art without departing from the scope and spirit of the invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. An apparatus for automatically identifying one or more network resources affected by a computer intrusion, the apparatus comprising:
a memory; and
at least one hardware device, coupled to the memory, operative to:
collecting information about an external system from an external source;
deriving a list of one or more affected internal systems on an internal network by correlating said information with internal information about internal systems that interacted with said external system; and
identifying one or more user accounts associated with said one or more affected internal systems.

13. The apparatus of claim 12, wherein said at least one hardware device is further configured to identify data residing on systems accessible by said one or more user accounts.

14. The apparatus of claim 12, wherein said at least one hardware device is further configured to present a list to a user of said network resources that may be affected by said computer intrusion.

15. The apparatus of claim 12, wherein said one or more network resources comprise one or more of servers, services and client machines.

16. The apparatus of claim 12, wherein said external source comprises one or more of a provider of an antivirus product and a law enforcement agency.

17. The apparatus of claim 12, wherein said external system comprises one or more of an infected system and a malicious system.

18. The apparatus of claim 12, wherein said internal information comprises one or more of internal network activity, internal e-mail content and authentication logs.

19. The apparatus of claim 12, wherein said step of deriving a list of one or more affected internal systems further comprises the steps of marking an identified internal system as infected and marking any additional internal systems that communicated with an identified external host as infected.

20. The apparatus of claim 19, further comprising the step of marking any internal system that communicated with an infected internal system as infected.

21. The apparatus of claim 19, further comprising the step of marking any internal system with a communication profile similar to an infected system as infected.

22. The apparatus of claim 12, wherein said one or more user accounts associated with said one or more affected internal systems comprises accounts of a user who has access to at least one of said affected internal systems.

23. An article of manufacture for automatically identifying one or more network resources affected by a computer intrusion, comprising a tangible machine readable recordable medium containing one or more programs which when executed implement the steps of:
collecting information about an external system from an external source;
deriving a list of one or more affected internal systems on an internal network by correlating said information with internal information about internal systems that interacted with said external system; and
identifying one or more user accounts associated with said one or more affected internal systems.

24. The article of manufacture of claim 23, wherein said internal information comprises one or more of internal network activity, internal e-mail content and authentication logs.

25. The article of manufacture of claim 23, wherein said step of deriving a list of one or more affected internal systems further comprises the steps of marking an identified internal system as infected and marking any additional internal systems that communicated with an identified external host as infected.

26. The article of manufacture of claim 23, further comprising the step of identifying data residing on systems accessible by said one or more user accounts.

27. The article of manufacture of claim 23, further comprising the step of presenting a list to a user of said network resources that may be affected by said computer intrusion.

28. The article of manufacture of claim 23, wherein said one or more network resources comprise one or more of servers, services and client machines.

29. The article of manufacture of claim 23, wherein said external source comprises one or more of a provider of an antivirus product and a law enforcement agency.

30. The article of manufacture of claim 23, wherein said external system comprises one or more of an infected system and a malicious system.

31. The article of manufacture of claim 23, wherein said internal information comprises one or more of internal network activity, internal e-mail content and authentication logs.

32. The article of manufacture of claim 23, wherein said one or more user accounts associated with said one or more affected internal systems comprises accounts of a user who has access to at least one of said affected internal systems.
